(19) United States
(12) Patent Application Publication
(10) Pub. No.: US 2008/0104045 A1
(43) Pub. Date: May 1, 2008

(54) Collectively enhanced semantic search

(76) Inventors: Alain J. Cohen, Washington, DC (US); Marc A. Cohen, Washington, DC (US)

Correspondence Address: ROBERT M. MCDERMOTT, ESQ., 1824 FEDERAL FARM ROAD, MONTROSS, VA, 22520, US

(21) Appl. No.: 11/591,763

(22) Filed: Nov. 1, 2006

(51) Int. Cl. G06F 17/30

(52) U.S. Cl. 707/4

(57) ABSTRACT

A search system analyzes a user's search requests and identifies prior semantically-similar search requests that have provided well-received results. Each search request is classified, based on the semantics of the search request, and the user's satisfaction with the effectiveness of the search request is monitored and recorded within the determined class (or set of classes). As a particular user's search session continues, the classification of the user's search request is also used to identify other searches in the determined class, and the user is provided the option of modifying or replacing the user's current request with one of these semantically similar searches. The system may also be configured to identify the most favored results provided by these semantically similar searches, and allow the user to select from among these results. The system may also provide incremental updates over time, as new results or new semantically-similar search requests are found.

This application claims the benefit of U.S. Provisional Patent Application 60/732,067, filed 1 Nov. 2005.

### BACKGROUND AND SUMMARY OF THE INVENTION

This invention relates to the field of information processing and retrieval, and in particular to techniques that enhance the abilities of search engines and other tools used to retrieve information.

The amount of information that is available ‘on-line’ continues to grow exponentially, and existing search techniques are proving to be increasingly inadequate. Strides have been made toward ‘qualifying’ the available information and using the resultant quality measure to filter the results of searches, so that search engines are less prone to return ‘junk’, but such output filtering and/or ranking does not truly address the need for improved search and retrieval capabilities.

Advances have also been made in the area of ‘collective’ filtering, wherein the effectiveness of a result to satisfy a prior query is used to affect the results provided to a subsequent query. The collection of prior results and their effectiveness may be based on a single user's history, multiple users' histories, or a combination of each, with optional weightings used to influence the filtering. The determination of the effectiveness of each result is generally based on a combination of explicit and implicit feedback.

U.S. Patent Application 2005/0125390, “AUTOMATED SATISFACTION MEASUREMENT FOR WEB SEARCH”, filed 22 Mar. 2004 for Hurst-Hiller et al. teaches techniques for evaluating user satisfaction with the results of a web search based on various implicit feedback events related to the user's behavior upon receipt of the results, including navigating to a new page, and whether the new page was included in the results, dwell time on a page, use of the ‘back’ button, saving a page as a favorite, copying information from a page, and so on, and is incorporated by reference herein. Techniques for obtaining explicit user feedback are also presented, including using a dialog box to query the user regarding the subsequent selection or non-selection of a given result. The stored rating of a given page is also dependent upon the context of the given query, such that the same page may have different ratings in different contexts. For example, a page on the book The Hitchhiker's Guide to the Galaxy may be rated high for a search for “travel guides” in the context of science-fiction, but not in the context of foreign-travel. Based on the explicit and implicit rating of pages in different contexts by many users, when a new query in a given context is submitted, a satisfaction measure is predicted for each page that appears to satisfy the query. The satisfaction measure is then used to evaluate the performance of a given search engine (whether the search engine's results includes pages that are likely to be satisfactory to the user), to identify anomalous search engine behavior (whether certain queries exhibit different satisfaction predictions based on demographics, language, and so on), to improve search performance (training a learning-enabled search engine based on the predicted satisfaction), and to improve search outputs (ordering results based at least in part on the predicted satisfaction), and so on.

In a related field, U.S. Pat. No. 6,438,579, “AUTOMATED CONTENT AND COLLABORATION-BASED SYSTEM AND METHODS FOR DETERMINING AND PROVIDING CONTENT RECOMMENDATIONS”, issued 20 Aug. 2002 to Benjamin E. Hosken, and incorporated by reference herein, teaches a content and collaborative filtering system for recommending entertainment oriented content items. This system includes a referral system that provides a recommended set of material based on a user's request, the user's profile, and a database of available material that is weight-filtered by ‘expert’ and ‘collected group behavior’ ratings. The system correlates a similarity between the user's rating of content items and other users' ratings, and determines the ‘collected group’ based on this similarity. In this manner, the database of available material includes expert-recommended material that has a high probability of being favored by the user, based on the similar-users' ratings.

A problem that is common to most proposed techniques for improving the quality of search results, including the above referenced prior art, is that these techniques generally focus on the results of the search. That is, given the results of a search, the improvements generally address filtering and ordering the results for a particular user so that the user is presented a satisfactory subset of the results. As noted above, however, the filtering and ordering the output of searches is becoming increasingly less efficient and effective as the amount of available information content continues to increase.

A basic premise of this invention is that improvements to the search input process will have a significantly greater effect on the efficiency and effectiveness of search engines than processes that focus on improvements to the presentation of the output of the search process.

U.S. Pat. No. 6,853,998, “CUSTOMER SELF SERVICE SUBSYSTEM FOR CLASSIFYING USER CONTEXTS”, issued 8 Feb. 2005 to Biebesheimer et al. and incorporated by reference herein, teaches an interactive system to facilitate the creation and/or selection of a context space within which queries are processed. The user submits a query and an initial context vector, which may be newly created or retrieved from collection of prior context vectors. The query and context vector are processed against data in a context attribute database and context attribute function database for predicting the user's context, based on past interactions of this user, as well as other users. A classifier populates a user's context vector with context parameters that serve to define a user interaction state for use in a subsequent search. The user may use this determined/predicted context directly, or may edit each of the fields in the context vector, and may set weighting criteria for filtering and ordering the output results. In this manner, the user is relieved of the nonproductive work of describing the user's context in detail, and the search results are improved by including criteria derived from both data and behaviors in a general population that may be unknown to the user.

Advantages can be gained by improving the search input process. An advantage can be gained by improving the effectiveness of a search by improving the search request. An advantage can also be gained by improving the effectiveness of a particular user's search by modeling successful search requests of other users. A further advantage can be gained by allowing the search to persist for an extended period of time.

These advantages, and others, can be realized by a search system that analyzes a user's search requests and identifies prior semantically-similar search requests that have provided well-received results. These prior search requests include prior searches by the user, as well as other users. Each search request is classified, based on the semantics of the search request, and the user's satisfaction with the results of the search request is monitored and recorded within the determined class (or set of classes). As a particular user's search session continues, the classification of the user's search request is also used to identify other searches in the determined class, and the user is provided the option of modifying or replacing the user's current request with one of these semantically similar searches. The system may also be configured to identify the most favored results provided by these semantically similar searches, and allow the user to select from among these results. Recognizing that a user's interests will often result in repeated semantically-similar search requests, the system is also configured to provide incremental updates over time, based on the same request, as new results or new semantically-similar search requests are found.

### BRIEF DESCRIPTION OF THE DRAWINGS

The invention is explained in further detail, and by way of example, with reference to the accompanying drawings wherein:

FIG. 1 illustrates an example block/flow diagram of a search system in accordance with this invention.

FIG. 2 illustrates an example flow diagram of a user interaction with a search system of this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

The gap between the user's specified intent and the search engine's results is sometimes referred to as a lack of “semantic search” capability. This is due to the fact that the search capability is based on literal words and not the meaning of the words. In the context of an Internet search engine system, an approach would be for the search engine to understand the meaning behind the query and also the meaning of the information expressed within a document, and then to perform a “match on meaning”, rather than a “match on words”. In the case of the Internet, the set of available information is very vast in scale, very disparate in nature, and requires very little organization or coordination by the authors. However, even though the ‘meaning’ of the content material may be indeterminable, a premise of this invention is that the ‘meaning’ of search requests can be used to improve the performance of a search engine.

The invention provides a novel mechanism that introduces a higher level of intelligence and semantic processing capability to the users of a search engine, by providing a collectively enhanced semantic search capability. The invention leverages additional information that traditional search engines do not use when responding to a query. The invention can be embodied in a variety of forms, within a search engine, as a pre-processor to an existing search engine, and so on. Although the invention is particularly well suited for Internet searches, the principles of this invention may be used in an internal or private network setting as well. In like manner, although the invention is presented in the context of human “users”, the invention may be also used by other programs or machines accessing a search service, and may be accessed directly or indirectly via other programs or machines.

The invention is presented herein using the paradigm of a community of users that address queries to a common search engine. The system of this invention accumulates knowledge from the community and uses this knowledge to further enhance and refine the information that it presents in response to future searches. The paradigm includes the issuance of a search request, and in response to this request, the system returns the search results in an organized form, such as the typical “search results page” that includes a list of references to documents that are responsive to the search. The user may take a subsequent action related to the search, such as selecting a document from among those referenced in the list, or further refining the search, and so on. The user may subsequently return to the search results page, again to look at other documents, to narrow the search, or to go ‘back’ to a prior state. For ease of reference, the term ‘document’ is used herein to identify items referenced in the search results, although one of skill in the art will recognize that the items satisfying a request need not be limited to documents, and that the collection of items returned need not be limited to a list.

Knowledge is gathered from the user community using techniques common in the art, and, of particular note, techniques that assess the user's use of the results of a search. These assessments may include both implicit and explicit feedback from the user, and serve to assess the user's satisfaction with the results provided by the search engine. For ease of reference, the term ‘quality’ is used to define the aspects of a search that lead to user satisfaction. That is, the search quality is ‘high’ if users are satisfied with the results, and ‘low’ if users are dissatisfied with the results.

As contrast to, or complimentary to, the conventional use of the assessments of the user's subsequent behavior to evaluate the quality of each of the returned documents, a principle of this invention is the use of these assessments to evaluate the quality of the search request itself. That is, for example, if the user immediately hits the ‘back’ button after receiving a list of items resulting from a given search, the conclusion is reached that the search was ineffective. In a conventional system, each of the returned items would be rated unsatisfactory for the given search query in the current context, or at least not given credit as being a satisfactory response to the search query. Alternatively, this invention recognizes that the ‘fault’ may not lie with the results found, but rather, with the search request, and the request itself is rated as unsatisfactory. In like manner, if the assessment of the user's behavior indicates that the search results were well received, ‘credit’ for the success of the search is given to the search request, as well as to the items satisfying the search.

As in the case of evaluating results based on the context of a search query, it is recognized that the effectiveness of a search request is dependent upon the context within which the search request is formulated. The system of this invention is preferably configured to recognize ‘search sessions’ that form the context within which the meaning of each search request can be interpreted. As indicated above, the information associated with a search session includes an identification of the search space within which the session progresses, as well as information regarding the user's behavior as search results are provided, and as the various paths are taken to refine the search space. Preferably, the search session spans the entire sequence of interactions that pertain to the same user objective for obtaining information on a particular topic of interest. Search sessions may be explicitly or implicitly delineated, may be saved and recalled for subsequent continuation or to initialize a new session, and so on.

In general terms, a search request comprises the submission of search criteria to a search engine in a form that is suitable for the search engine to process. Because the principles of this invention are not limited to a particular search engine, or particular class of search engines, the term search criteria is used hereinafter to distinguish the information content of the search request from the particular form of the request. As the term is used herein, and as discussed further below, the search criteria preferably includes any information that facilitates the determination of the contextual meaning of the search. The particular form used to store and manage the search criteria to facilitate this determination will be dependent upon the particular embodiment of this invention, and the following description is not intended to limit such embodiments.

In an example embodiment, search criteria is represented as a data object that captures the information specified by the user when the search is submitted, and the search system includes a repository that contains the various search criteria objects. In the context of this example, an object is any information storage construct that facilitates storage and retrieval of related pieces of information. An object may be implemented by means of database records, database objects, data structures, files, and so on. Information can be added to or associated with each search criteria object, including, for example: statistics pertaining to user behavior, user demographic information, time stamps, how often the object is used by the search engine in generating the response to a new query, and so on.

In a preferred embodiment, the search system is configured to dynamically update the search criteria objects and associated information, but in a less sophisticated embodiment, the updating may be semi-static, and may include selective updating via post-processing of stored information, and manual compilation. That is, although a preferred embodiment would be completely autonomous and include all search sessions, the principles of this invention may be applied in a manually assisted system that creates and updates select search criteria objects, such as those of common interest to a significant portion of the user community.

In a dynamically changing search system, new search criteria objects flow into the repository, based on new searches being performed by users, and existing objects are potentially removed over time, based generally on lack of use. Search objects may also be consolidated from time to time, based on a periodic or aperiodic schedule, or based on the growth patterns of related search objects. The consolidation may also be performed dynamically, as a new search object is found to correspond to a prior search object, and a merged object is formed that consolidates the information associated with each. Preferably, any of a variety of machine learning techniques, including expert systems, neural networks, genetic algorithms, and the like, are used to optimize the use of the collected search criteria objects to create sets of search criteria that are particularly effective based on the semantic content and context of the user's expressed or implied search objectives.

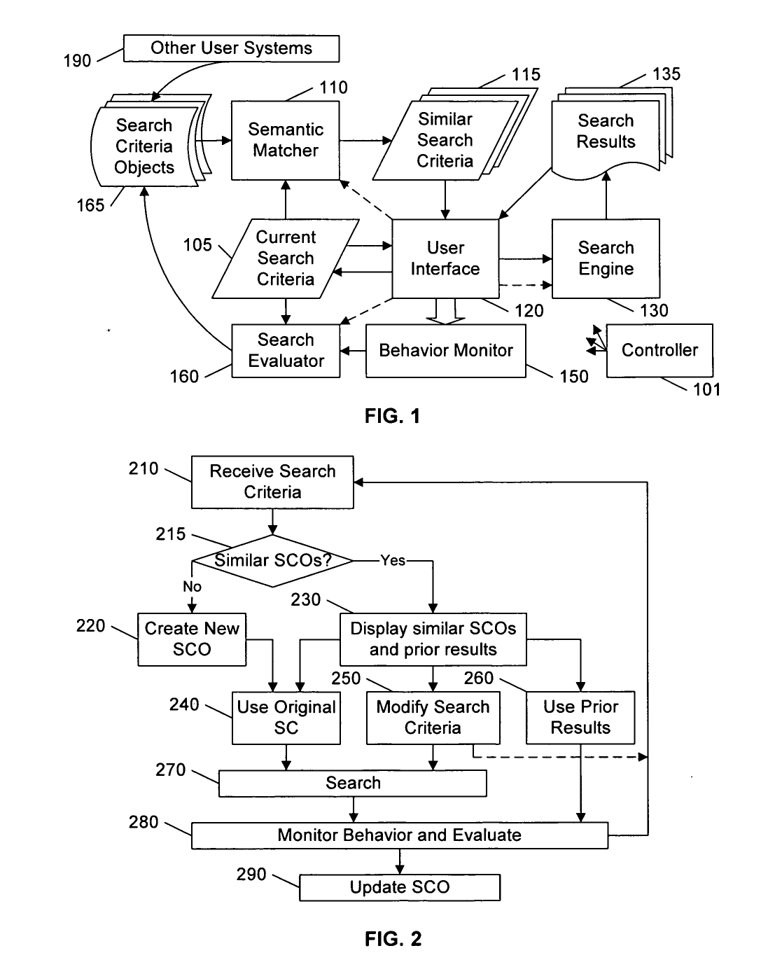

FIG. 1 illustrates an example block/flow diagram of a search system in accordance with this invention. A user interacts with a user interface 120 to create search criteria 105 for submission to a search engine 130. The search engine 130 provides results 135, with which the user may interact via the user interface 120. The user may subsequently modify the search criteria 105 and repeat the process until the user finds desired results, or abandons/postpones the search. A controller 101 manages the interactions among the variety of functional blocks, based on user directives, as well as automated processes and scripts as detailed below and as is typical in the art of interactive systems.

Throughout the search session, a behavior monitor 150 monitors the user interactions, and a search evaluator assesses the quality of the search, based on the user's behavior, which may include both implicit and explicit indications of the user's satisfaction with the search results. As noted above, in a preferred embodiment of this invention, the evaluator 160 is configured to evaluate both the search query itself, as well as the results provided, based on the user's implicit or explicit satisfaction determination. The implicit satisfaction determination based on the user's behavior, for example, may include whether the user proceeds to access web-pages identified in the search results, the amount of time spent before the user hits the ‘back’ button, and so on. The explicit satisfaction determination based on the user's behavior may be based on an answer to a system-generated query, a selection of a “thumbs-up” or “thumbs-down” button for one or more of the results, and so on. The determined satisfaction determination may be associated to all of the search criteria elements, or to particular search criteria elements, if the cause of the favorable or unfavorable result can be associated with specific search criteria elements. For example, if a particular search word or phrase has an alternative meaning that differs from its intended use by the user, and the search results imply the use of this alternative meaning, the user may provide a “thumbs-down” assessment of that word or phrase in the search criteria, instead of, or in addition to, an evaluation of the provided search results.

As noted above, a significant aspect of this invention is the recognition that improvements to a user's search criteria is likely to have a significant effect on the quality of the search results. A semantic matcher 110 is provided to identify one or more appropriate search criteria objects 165 in a repository that match the current search of interest 105. Semantic matching can be defined in various ways, and many different selection strategies and matching criteria can be implemented. The search criteria objects 165 are preferably designed to contain appropriate data to support the implemented matching strategy or set of strategies. For example, if, as discussed further below, the matching algorithm relies on a comparison of all verbs and nouns contained in the current search criteria, then the format of the search criteria object should provide for storing a list of verbs and nouns from prior searches.

The semantic matcher 110 attempts to identify prior search criteria that have the same meaning as the current search criteria, and can include a variety of strategies, depending upon the degree of complexity that can be supported in a given embodiment.

In a straightforward embodiment, search criteria that contain exactly the same words are likely to have the same meaning, and the semantic matcher 110 may be configured to use a literal matching algorithm. While this approach has the advantage of being straightforward to explain and to implement, it will not provide an enhancement to the user's current search criteria. It may be used, however, to illustrate a satisfaction rating for the prior search criteria, and the results provided, to possibly steer a user to modify the current search criteria before submitting the search request, or to remind the user that he/she has already submitted the same search request.

A preferred alternative to an exact match technique is a ‘fuzzy’ match technique that identifies ‘near matches’. Again, a variety of levels of complexity can be used to identify near-matches, ranging from matching alternative forms of the same word to an expert-like system that recognizes equivalences, and non-equivalences, based on context and some degree of ‘reasoning’, as used, for example, in natural-language processing systems.

By finding similar, but not exact search criteria matches, the system is able to provide alternative search criteria for the user's consideration. If, for example, a prior ‘similar’ search 115 exhibited a high level of user satisfaction, the user may modify the current search based on an appreciation of one or more of the criteria in the prior search, including, if desired, replacing the current search 105 with the prior search 115. For example, a current search may include criteria X, Y, and Z; and an identified similar search may include criteria X, Y1, and Z, where Y1 is a synonym for Y that the semantic matcher 110 had recognized, but the user hadn't considered. Or, the semantic matcher 110 may find similar searches 115 that included criteria X, Y, Z, and not(Q), or X, Y1, Z, and P that provided high quality search results, and the user interface 120 provides these high quality searches for the user's consideration. As discussed above, and as illustrated in FIG. 1, the collection of search criteria objects 165 used to find similar matches 115 to the current search criteria 105 preferably includes search criteria objects from other user systems 190, or, from the same system, accessed by different users, or a combination of both. In this manner, the experiences of other users is leveraged to improve the search experience of the current user.

Preferably, the semantic matcher 110 is used for the aforementioned consolidation of search criteria objects 165. An advantage of using a fuzzy matching technique in the semantic matcher 110 is that the likelihood of a fuzzy match will be substantially higher than an exact match, and therefore consolidations of search criteria objects will occur more often than consolidations based on exact matches.

As noted above, fuzzy matching can be accomplished in a number of ways, using techniques common in the art, such as:

Eliminate dissimilarities that are deemed to be semantically irrelevant. For example: replace all plural forms with singular forms; convert verb forms to present tense (e.g., “ate” becomes “eat”); remove punctuation; remove apostrophes; and remove prepositions.

Recognize which words are verbs, nouns, and adjectives, and form separate lists of each. Then, separately compare the content of each list in the SCO with its respective counterpart in the query.

Consider both order-dependent word phrases and order-independent words. This technique can be particularly helpful if applied in combination with those above.

Use a thesaurus-like capability to detect words and word phrases with equivalent or similar meaning and perform corresponding substitutions when making comparisons.

In addition to ‘fuzzy’ matching, other semantic matching techniques may be used as well. Of particular note, an aspect of this invention includes ‘empirical’ semantic matching, wherein searches that provide the same result, with a high level of user satisfaction for the same results are deemed to be semantically related, even though the search criteria itself does not imply a strong semantic equivalence. Such empirical matching may occur, for example, when one search criteria includes “toys” and “remote control”, while another includes “model” and “aircraft”. These search criteria are likely to provide differing search results, but it is likely that a strong correlation will exist between the pages favored by users of each criteria, so that a semantic similarity can be inferred between these two criteria.

As indicated by the dashed arrows, in addition to controlling the behavior of the search evaluator, the user interface 120 preferably also allows the user to control the behavior of the matching algorithm, to allow the user to exercise some degree of control over how the matcher 110 selects similar search criteria, including, for example, controlling the breadth of a match, and enabling or disabling particular matching mechanisms, such as whether to use the thesaurus for select criteria. Additionally, different matching criteria, or thresholds, can be set for differing sets of search criteria objects. For example, search criteria objects originating from the current user, or from users known to the current user, or from particular communities of users, may have a lower threshold for being considered semantically similar to a current search criteria than search criteria objects from unknown users.

In addition to providing direct control of the matcher 110, in a preferred embodiment, the user is also able to provide feedback regarding the suitability of the determined matches. If, for example, the user searches using criteria A and the matcher presents A1 and B as being semantically similar, the user can provide implicit or explicit feedback for one or both of the determined matches, to “strengthen” or “weaken” the semantic equivalence relationship among the search criteria objects of interest. Thus, while A, A1, and B might all still be maintained in the same equivalence class, there would be a measure of the strength of that equivalence for each of the pairs of search criteria objects. In a preferred embodiment, for example, a graph is formed among the objects and each edge of the graph carries a weight indicating the strength of the equivalence between objects. Edges that ultimately carry too low a score are removed, indicating that the pair of objects are no longer deemed to be equivalent. If the edges of an object to all of the other objects in the class are removed, the object is removed from the class. One of ordinary skill in the art will recognize that any of a variety of other machine learning techniques may also or alternatively be applied to effect improvements to the matching process based on user feedback.

The search criteria objects 165 may be stored in a variety of structures, generally ranging from a distributed storage architecture to a centralized storage architecture.

In a distributed storage architecture, individual search criteria objects that are not substantially identical are stored independently. To provide efficiency for the matching process, the relationships among these independent search criteria objects are also stored, to avoid repeated determinations of their semantic equivalences. Preferably all of the semantic relationships are stored, and the aforementioned user control of the semantic matching is effected via a filtering of these defined relationships. In this embodiment, consolidations are primarily effected by deleting objects that have not been accessed recently or frequently.

In a centralized storage architecture, the individual search criteria objects are merged into semantically equivalent search objects, as discussed above. The composite criteria associated with the merged object may be determined using any of a variety of techniques, generally based on a frequency of appearance of each criterion in the higher quality objects forming the set of equivalent search criteria objects. Techniques common in the art of pattern recognition can be used, for example, to identify the individual criteria that tend to lead to a quality search, such as cluster-based analysis, neural networks, genetic algorithms, and the like. In a preferred embodiment, the original search criteria used to form the composite is also stored, to facilitate understanding of the search progression, as well as to facilitate diagnosis of performance problems, or performance successes. As in the case of the distributed storage architecture, the relationships among the individual or merged search criteria objects is stored to avoid repeated determinations of their semantic relationships.

In a preferred embodiment, the relationships between and among search criteria objects is defined through the use of “equivalence classes” of search criteria. An equivalence class is a set of elements that are considered equivalent in some sense, as defined by an “equivalence relation”; in an example embodiment, the elements are search criteria, and the equivalence relation is semantic similarity. The equivalence classes can be determined by any type of equivalence evaluation function deemed appropriate, as discussed above, such as ‘exact’, ‘alternative form’, ‘synonym’, ‘antonym in context X’, and so on. In essence, the system maintains this information in much the same manner as a thesaurus organizes relationships among related words or phrases. In the case of a thesaurus, each of many related words refers back to a common record or “word group”. Armed with one word, the thesaurus user can find the word group to which it belongs, and in turn discover all of the other members of the group, as well as any associated information, such as definitions, etc. For the thesaurus, the elements are words, and the equivalence classes are groups of words; the equivalence relation that binds them is semantic similarity, dissimilarity (for non-equivalence determinations), modified in some cases by context, and so on, as in the case of the search system of this invention.

FIG. 2 illustrates an example flow diagram of a user interaction with a search system of this invention.

At 210, the user submits search criteria; this search criteria may be, for example, an initial search criteria for a search session, a search criteria from a prior search session, or a modification 235 of search criteria in the current session.

At 215, the repository of prior search criteria objects is searched to identify one or more semantically similar search criteria objects.

If, at 215, a similar search criteria object is not found, a new search criteria object is created, at 220. This object will include the submitted criteria, and, if not yet included in the criteria, information regarding the particular search and search session, including context parameters, prior search criteria, and the like, as discussed above. Because this is a new search criteria object, it will not yet include an indication of the results provided by a search using this criteria, nor an evaluation of the quality of such a search.

If, at 215, one or more similar search criteria objects are found, they are displayed to the user, preferably in a priority order based on the rated quality of the prior search using this criteria. Preferably, the search criteria object includes a sample of the prior results, and the user is provided the option of accessing these results directly, at 260, without executing another search. At this point, the user may choose to execute the search, at 270, using his/her originally submitted search criteria, at 240, or using a modified search criteria, based on the criteria of one or more of the similar search criteria objects, at 250, including replacement of the original search criteria, if desired. Optionally, the modified search criteria may be re-submitted directly to the matching process for further refinement prior to submission as a new search, as indicated by the dashed arrow from 250.

As noted above, the user may modify the original search criteria by replacing it with a prior search criteria. Although it may appear redundant to resubmit previously submitted search criteria, the dynamic nature of the search environment may provide different results for the same search criteria at different times. For example, new material may have entered the environment, a different search engine may be used, and so on. Additionally, as noted above, the user interface may only present a sample of the prior search results, and a current user may prefer to see additional results. In like manner, the search engine may be configured to use user-profiles to determine the order or manner in which results are presented to each user, and thus the use of the same search criteria by different users is likely to produce some variation in the presented material. Similarly, the submission of the same search criteria in different contexts may also provide different results.

The user may conduct a variety of activities before reinitiating the search process by modifying the search criteria, at 235. Using techniques common in the art, the user's behavior is monitored, at 280, and this behavior is used to evaluate the quality of the search criteria and the quality of the search results, whether directly obtained, via 260, or obtained as a result of the search at 270. The corresponding search criteria object is updated to reflect this evaluation, at 290.

Although not illustrated, one of ordinary skill in the art will recognize that the effects of the evaluation of the search are not limited to the immediate search criteria object that provided the results, and may extend back through prior search criteria objects that led to the current results. That is, for example, prior search criteria objects can be allocated some credit for leading to a subsequent successful search, or allocated some penalty for leading to a dead end.

As discussed above, the system is configured to display similar search criteria objects to a user, to facilitate the selection of alternative search criteria as desired. Of particular note, the search criteria objects in a preferred embodiment of this invention include a variety of meta-data associated with the alternative search criteria, one of which meta-data items including the aforementioned evaluation of the effectiveness, or quality, of this search criteria for satisfying users who have used the request. Other meta-data is also provided to facilitate the user's selection of the search criteria, including, for example, the number of times this search criteria has been used, the most recent time of use, relationships to other search criteria objects, and so on. In a preferred embodiment, the user is provided the option of adding meta-data in the form of explicit comments regarding the particular search criteria object, an explicit ranking, suggestions for other search criteria objects, and so on.

The meta-data fields may also be used, for example, to allow a user to identify his/her skill level in the field of the search criteria, so that the user's satisfaction rating can be evaluated in the context of the user's purpose for performing the search. For example, a particular search for information regarding ruins in Greece may provide results that are deemed very satisfactory to a person with a casual interest in archeology, but wholly unsatisfactory to a researcher in the field, and vice versa. By allowing another user to view such meta-data, the user can determine the relative weight to place in the quality of either the search criteria or the provided results.

Note that although the system of this invention is particularly well suited for improving a user's search based on the quality of searches of other users, it is also well suited for a personal search system, particularly if the user frequently searches within the same field. For example, this invention is well suited for use by a patent examiner on an individual basis as well as within a collaborative network of other examiners. In the individual system, the patent examiner could use the aforementioned meta-data fields to ‘leave notes for himself/herself’ regarding particular search criteria and/or particularly broad prior art within the search field.

In like manner, a researcher within a given field may repeatedly perform similar searches with slight variations as new areas/avenues are being researched, or without variation, to determine if changes have occurred in the field since the last search. The meta-data fields within a search criteria object allow the researcher to annotate the search to facilitate recollections of prior events and activities. For example, the researcher may use the meta-data field to identify the location of a summary paper that the researcher prepared based on the results of the particular search.

The aforementioned display of search criteria objects and associated meta-data may be performed using a variety of techniques common in the art of displaying information and relations among the information. Preferably, the user is given the option of selecting preferred display formats for different categories of information, or for different analysis purposes. In some situations, for example, a simple list of matching objects may be appropriate; in other situations, graphs or other visual aids may be presented to illustrate the relationships among the objects. In like manner, the ‘scoring’ of objects may be presented merely as an ordered list ranked by score, as a bar chart that illustrates each object's score, as a collage with higher scoring objects presented more prominently, and so on.

In a preferred embodiment of this invention, other tools are also provided to assist those who perform repeated similar searches, including the ability to launch a search using a given search criteria object and receiving ongoing incremental results. As noted above, the search environment is often dynamic, and a user may be interested in ongoing changes within the scope of the search criteria. In addition to, or alternative to, providing incremental search results, the system may be configured to provide incremental updates regarding the status of the search criteria object, such as the detection of a new search criteria that semantically matches the search criteria object, particularly if this new search criteria is reported as having a substantially higher quality/satisfaction measure than the search criteria used thus far. In a preferred embodiment, the user is provided options regarding the duration of this extended duration search session, the criteria used to notify the user of a change of status of either the search results or the search criteria object, the method of notification, and so on.

As noted above, in a preferred embodiment, search sessions may extend across multiple individual interactions, based on a continuing search context. In a preferred embodiment, a user may create a new session or open an existing session, perform searches, refine and edit the searches, form unions, intersections, or other combinations of search result sets, and so on. At any time, the user may suspend the session and resume it at a later time, or place it in an incremental update mode, as detailed above. The user may also merge search sessions that are subsequently determined to be related, delete outdated sessions, and perform other modification and maintenance tasks common to conventional database systems.

Although this invention is presented in the context of cooperating single user systems, one of ordinary skill in the art will recognize that the principles of this invention can be embodied in a variety of forms. In a corporate environment, for example, wherein it may be assumed that personnel in the same department will likely be seeking information in the same field, the system can be configured to maintain a collection of search criteria objects for each department, wherein the behavior of each user in the department is monitored to assess and evaluate the effectiveness of this departmental database of search criteria objects. In a less restrictive environment, such as the environment of all Internet users, a search engine provider may allow each user to subscribe to a ‘general’ membership of users, or, for an additional cost, subscribe to one or more ‘special interest’ groups. Alternatively, or additionally, user profiles may be created, explicitly or implicitly, to identify the general and special interests of each user, and these profiles may be used to control each user's participation as receiving and contributing members of groups associated with different sets of search criteria objects.

In like manner, different filtering of collective feedback can be applied at different levels of distributed sets of search criteria objects. Each user may have access to each past search criteria object associated with his/her use of the system, but may only be provided with search criteria from other users that satisfy certain criteria, such as surpassing a given threshold level of user satisfaction. The threshold applied to accepting search criteria objects of other users within a user's family, or within a user's workgroup, may be lower than the threshold set for accepting search criteria from associates of the user, or from a similar age group as the user, which may be lower than the threshold set for accepting search criteria from strangers to the user, and so on. In like manner, when multiple similar search criteria objects are found, a weighting function can be applied to determine the order in which these objects are presented to the user, wherein the weights are based on the relationship between the user and the source of the search criteria object, or other factors determinable from the meta-data of each search criteria object.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

We claim:

1. A search system comprising:
a user interface that is configured to receive current search criteria,
a comparator that is configured to compare the current search criteria to a plurality of search criteria objects, to identify one or more similar search criteria objects, and
a controller that is configured to present the one or more similar search criteria objects to a user via the user interface, to allow the user to modify the current search criteria based on the one or more similar search criteria objects.

2. The search system of claim 1, including:
a search engine that is configured to provide search results corresponding to the current search criteria,
a behavior monitor that is configured to assess behavior of the user following receipt of the search results, and
a search evaluator that is configured to:
provide an evaluation of the current search criteria based on the assessed behavior of the user, and
modify a search criteria object corresponding to the current search criteria based on the evaluation of the current search criteria.

3. The search system of claim 2, wherein
the search evaluator is configured to create the search criteria object corresponding to the current search criteria.

4. The search system of claim 2, wherein
the plurality of search criteria objects includes search criteria objects from a plurality of users.

5. The search system of claim 2, wherein
the comparator includes a semantic matcher that is configured to compare the current search criteria to the plurality of search criteria objects based on semantic content of the current search criteria.

6. The search system of claim 2, wherein
the controller is configured to automatically re-submit the current search criteria to the search engine to receive subsequent search results at a subsequent time, and to store the subsequent search results associated with the current search criteria over time.

7. The search system of claim 6, wherein
the controller is configured to report differences between the search results and the subsequent search results.

8. The search system of claim 1, wherein
the comparator includes a semantic matcher that is configured to compare the current search criteria to the plurality of search criteria objects based on semantic content of the current search criteria.

9. The search system of claim 8, wherein
the semantic content includes a context within which the current search criteria was formed.

10. The search system of claim 8, wherein
the semantic matcher identifies similar search criteria objects based on parts of speech contained in the current search criteria.

11. The search system of claim 8, wherein
the semantic matcher identifies similar search criteria objects by ignoring dissimilarities that are semantically irrelevant.

12. The search system of claim 8, wherein
the semantic matcher identifies similar search criteria objects based on an order of words contained in the current search criteria.

13. The search system of claim 8, wherein
the semantic matcher identifies similar search criteria objects without regard to an order of words contained in the current search criteria.

14. The search system of claim 8, wherein
the semantic matcher identifies similar search criteria objects based on synonyms of words contained in the current search criteria.

15. The search system of claim 8, wherein
the semantic matcher identifies similar search criteria objects based on similarities of search results.

16. The search system of claim 8, wherein
the semantic matcher is configured to use a configurable process to compare the current search criteria to the plurality of search criteria objects, and
the controller is configured to modify the configurable process based on user feedback.

17. The search system of claim 16, wherein
the configurable process includes:
a network of nodes corresponding to the search criteria objects, and
edges that connect pairs of select nodes, each edge including a weight that corresponds to a similarity between each corresponding pair of search criteria objects, and
the controller is configured to modify one or more of the weights based on the user feedback.

18. The search system of claim 16, wherein
the configurable process includes at least one of: a learning system, an expert system, a genetic algorithm, and a neural network.

19. The search system of claim 1, wherein
the plurality of search criteria objects are stored in a data structure, and
the data structure includes a plurality of relationships among the search criteria objects.

20. The search system of claim 19, wherein
the search criteria objects and the relationships form equivalence classes, each equivalence class including a set of search criteria, and an equivalence relation that links the search criteria with the set.

21. The search system of claim 20, wherein
the equivalence relation includes one of: exact correspondence, alternative form, synonym, and antonym.

22. The search system of claim 20, wherein
one or more of the equivalence relations is based on context.

23. The search system of claim 19, wherein
the data structure corresponds to a thesaurus-like structure that links related search criteria.

24. The search system of claim 19, wherein
the comparator includes a pattern recognition system that is configured to identify the relationships among the search criteria objects.

25. The search system of claim 24, wherein
the pattern recognition system includes at least one of: a cluster-analysis system, a genetic algorithm system, a neural network system, and a machine-learning system.

26. The search system of claim 19, wherein
the data structure includes meta-data that is associated with one or more of the plurality of search criteria objects, and
the controller is configured to enable display of the meta-data.

27. The search system of claim 26, wherein
the meta-data includes at least one of: a measure of effectiveness of the search criteria object, a frequency of use of the search criteria object, a time of last use of the search criteria object, and a user comment related to the search criteria object.

28. The search system of claim 27, wherein
one or more past search results are associated with the search criteria object, and
the meta-data includes, within context of the search criteria object, at least one of: a measure of effectiveness of the past search results, a frequency of access to material associated with the past search results, a time of last access to the material, and a user comment related to the past search results.

29. The search system of claim 27, wherein
the user comment includes at least one of: a satisfaction rating, a context, a skill-level, a genre, a topic, a field of search, and a link to other material.

30. The search system of claim 26, wherein
the meta-data includes at least one of: an age, a profession, one or more interests, a skill- level, and a gender.

31. The search system of claim 1, wherein
the controller is configured to facilitate storing the current search criteria.

32. The search system of claim 31, wherein
the controller is configured to enable the comparator to compare the current search criteria, after modification, to the plurality of search criteria objects to identify one or more additional similar search criteria objects to the user, for subsequent modifications to the current search criteria.

33. The search system of claim 32, wherein
the controller is configured to store a trace of the modifications to the current search criteria over time.

34. The search system of claim 33, wherein
the controller is configured to store one or more of the similar search criteria objects associated with the modifications to the current search criteria over time.

35. The search system of claim 33, wherein
the controller is configured to enable the user to recall the trace of the modifications at a subsequent period of time, and to continue to modify the recalled current search criteria.

36. The search system of claim 33, including
a search engine that is configured to provide search results corresponding to the current search criteria,
wherein
the controller is configured to store select search results associated with the modifications to the current search criteria over time.

37. The search system of claim 36, including
a behavior monitor that is configured to assess behavior of the user following receipt of the search results, and
a search evaluator that is configured to:
provide an evaluation of the current search criteria based on the assessed behavior of the user, and
modify a search criteria object corresponding to the current search criteria based on the evaluation of the current search criteria.

38. The search system of claim 37, wherein
the controller is configured to store changes to the search criteria objects associated with the modifications to the current search criteria over time.

39. The search system of claim 38, wherein
the search criteria objects include meta-data that facilitate identification of a context associated with the search criteria object.

40. The search system of claim 39, wherein
the meta-data is associated with a user of the search criteria object and includes at least one of: an age, a profession, one or more interests, a skill-level, and a gender.

41. The search system of claim 39, wherein
the meta-data is associated with one or more search results associated the search criteria object and includes at least one of: a topic, a genre, a skill-level, and a profession.

42. The search system of claim 39, wherein
the meta-data identifies one or more other information items associated with the search criteria object.

43. The search system of claim 39, wherein
the controller is configured to enable the user to recall the trace of the modifications to the current search criteria at a subsequent period of time and at least one of the select search results and the changes to the search criteria objects associated with the modification, and to continue to modify the recalled current search criteria.

44. The search system of claim 43, wherein
the controller is configured to automatically re-submit the current search criteria to the search engine to receive subsequent search results at a subsequent time, and to store the subsequent search results associated with the current search criteria over time.

45. The search system of claim 44, wherein
the controller is configured to report differences between the search results and the subsequent search results.

46. The search system of claim 1, wherein
the user interface is configured to display the current search criteria, and a plurality of similar search criteria objects.

47. The search system of claim 46, wherein
the comparator is configured to determine relationships among the plurality of similar search criteria objects, and
the user interface is configured to display the relationships among the plurality of similar search criteria objects using a graphical representation of the relationships.

48. The search system of claim 47, wherein
the graphic representation includes a network of nodes with links between the nodes.

49. The search system of claim 48, wherein
the relationships include a similarity weighting factor between pairs of similar search criteria objects, and
the user interface is configured to configure the graphic representation based on the similarity weighting factors.

50. The search system of claim 46, wherein
the comparator is configured to determine a measure of similarity between the current search criteria and each of the plurality of similar search criteria objects, and
the user interface is configured to display the measure of similarity using a graphical representation of the measure.

51. The search system of claim 46, wherein
the user interface is configured to display one or more search results associated with the plurality of similar search criteria objects.

52. The search system of claim 46, wherein
the user interface is configured to facilitate the user's modifying of the current search criteria by graphic manipulation of the displayed plurality of similar search criteria objects.

53. A search system comprising:
a user interface,
a memory, and
a controller that is configured to allow a user to:
initiate a search session via the user interface,
define search criteria for submission to a search engine,
receive search results from the search engine,
review prior search criteria and prior search results,
modify the search criteria for submission to a search engine,
pause the search session by storing a current state of the search session to the memory, and
resume the search session at a subsequent time by recalling the current state of the search session from the memory.

54. The search system of claim 53, wherein
the state of the search session includes the search criteria and one or more of the prior search criteria and prior search results.

55. The search system of claim 54, wherein
the state of the search session includes a context that is associated with the search session.

56. The search system of claim 55, wherein
the context includes one or more demographics associated with the user.

57. The search system of claim 56, wherein
the demographics include one or more of: an age, a gender, a profession, an interest, and a skill-level.

58. The search system of claim 54, wherein
the state of the search session includes a trace of modifications of the search criteria over time.

59. The search system of claim 58, wherein
the state of the search session includes meta-data associated with at least one of the past search criteria and the past search results.

60. The search system of claim 59, wherein
the meta-data includes at least one of: a measure of effectiveness of the past search criteria, a frequency of use of the past search criteria, a time of last use of the past search criteria, and a user comment related to the past search criteria.

61. The search system of claim 59, wherein
the meta-data includes at least one of: a measure of effectiveness of the past search result, a frequency of access to material associated with the past search result, a time of last access to the material, and a user comment related to the past search result.

62. The search system of claim 59, wherein
the user comment includes at least one of: a satisfaction rating, a context, a skill-level, a field of search, and a link to other material.

63. The search system of claim 53, wherein
the controller is configured to automatically:
resume the search session at a subsequent time,
resubmit the search criteria to the search engine,
receive subsequent search results from the search engine, and
pause the search session by storing a new current state of the search session to the memory.

64. The search system of claim 63, wherein
the controller is configured to notify the user of differences between the search results and the subsequent search results.

65. A method comprising:
receiving a current search criteria,
comparing the current search criteria to a plurality of search criteria objects, to identify one or more similar search criteria objects, and
presenting the one or more similar search criteria objects to a user, to allow the user to modify the current search criteria based on the one or more similar search criteria objects.

66. The method of claim 65, including:
submitting the current search criteria to a search engine,
receiving search results corresponding to the current search criteria,
monitoring behavior of the user following receipt of the search results,
providing an evaluation of the current search criteria based on the assessed behavior of the user,
modifying a search criteria object corresponding to the current search criteria based on the evaluation of the current search criteria.

67. The method of claim 65, including
creating the search criteria object corresponding to the current search criteria.

68. The method of claim 67, wherein
the plurality of search criteria objects includes search criteria objects from a plurality of users.

69. The method of claim 67, wherein
comparing the current search criteria to the plurality of search criteria objects is based on semantic content of the current search criteria.

70. The method of claim 67, including:
automatically re-submit the current search criteria to the search engine,
receiving subsequent search results at a subsequent time, and
storing the subsequent search results associated with the current search criteria over time.

71. The method of claim 70, including
reporting differences between the search results and the subsequent search results.

72. The method of claim 65, wherein
comparing the current search criteria to the plurality of search criteria objects is based on semantic content of the current search criteria.

73. The method of claim 72, wherein
the semantic content includes a context within which the current search criteria were formed.

74. The method of claim 65, wherein
comparing the current search criteria to the plurality of search criteria objects is based on parts of speech contained in the current search criteria.

75. The method of claim 65, wherein
comparing the current search criteria to the plurality of search criteria objects includes ignoring dissimilarities that are semantically irrelevant.

76. The method of claim 65, wherein
comparing the current search criteria to the plurality of search criteria objects is based on an order of words contained in the current search criteria.

77. The method of claim 65, wherein
comparing the current search criteria to the plurality of search criteria objects is based on synonyms of words contained in the current search criteria.

78. The method of claim 65, wherein
comparing the current search criteria to the plurality of search criteria objects is based on similarities of search results.

79. The method of claim 65, wherein
comparing the current search criteria to the plurality of search criteria objects includes using a configurable process to compare the current search criteria to the plurality of search criteria objects, and
the method includes modifying the configurable process based on user feedback.

80. The method of claim 79, wherein
the configurable process includes:
a network of nodes corresponding to the search criteria objects, and
edges that connect pairs of select nodes, each edge including a weight that corresponds to a similarity between each corresponding pair of search criteria objects, and
modifying the configurable process includes modifying one or more of the weights based on the user feedback.

81. The method of claim 79, wherein
the configurable process includes at least one of: a learning system, an expert system, a genetic algorithm, and a neural network.

82. The method of claim 65, including
storing the plurality of search criteria objects in a data structure, and
the data structure includes a plurality of relationships among the search criteria objects.

83. The method of claim 82, wherein
the search criteria objects and the relationships form equivalence classes, each equivalence class including a set of search criteria, and an equivalence relation that links the search criteria with the set.

84. The method of claim 83, wherein
the equivalence relation includes one of: exact correspondence, alternative form, synonym, and antonym.

85. The method of claim 83, wherein
one or more of the equivalence relations is based on context.

86. The method of claim 82, wherein
the data structure corresponds to a thesaurus-like structure that links related search criteria.

87. The method of claim 82, wherein
the comparator includes a pattern recognition system that is configured to identify the relationships among the search criteria objects.

88. The method of claim 87, wherein
the pattern recognition system includes at least one of: a cluster-analysis system, a genetic algorithm system, a neural network system, and a machine-learning system.

89. The method of claim 82, wherein
the data structure includes meta-data that is associated with one or more of the plurality of search criteria objects, and
the controller is configured to enable display of the meta-data.

90. The method of claim 89, wherein
the meta-data includes at least one of: a measure of effectiveness of the search criteria object, a frequency of use of the search criteria object, a time of last use of the search criteria object, and a user comment related to the search criteria object.

91. The method of claim 90, wherein
one or more past search results are associated with the search criteria object, and
the meta-data includes, within context of the search criteria object, at least one of: a measure of effectiveness of the past search results, a frequency of access to material associated with the past search results, a time of last access to the material, and a user comment related to the past search results.

92. The method of claim 90, wherein
the user comment includes at least one of: a satisfaction rating, a context, a skill-level, a genre, a topic, a field of search, and a link to other material.

93. The method of claim 89, wherein
the meta-data includes at least one of: an age, a profession, one or more interests, a skill-level, and a gender.

94. The method of claim 65, including
storing the current search criteria.

95. The method of claim 94, including
comparing the current search criteria, after modification, to the plurality of search criteria objects to identify one or more additional similar search criteria objects to the user, for subsequent modifications to the current search criteria.

96. The method of claim 95, including
storing a trace of the modifications to the current search criteria over time.

97. The method of claim 96, including
storing one or more of the similar search criteria objects associated with the modifications to the current search criteria over time.

98. The method of claim 96, including
enabling the user to recall the trace of the modifications at a subsequent period of time, and to continue to modify the recalled current search criteria.

99. The method of claim 96, including
submitting the current search criteria to a search engine,
receiving search results corresponding to the current search criteria, and
storing select search results associated with the modifications to the current search criteria over time.

100. The method of claim 99, including:
determining behavior of the user following receipt of the search results,
providing an evaluation of the current search criteria based on the assessed behavior of the user, and
modifying a search criteria object corresponding to the current search criteria based on the evaluation of the current search criteria.

101. The method of claim 100, including
storing changes to the search criteria objects associated with the modifications to the current search criteria over time.

102. The method of claim 101, wherein
the search criteria objects include meta-data that facilitate identification of a context associated with the search criteria object.

103. The method of claim 102, wherein
the meta-data is associated with a user of the search criteria object and includes at least one of: an age, a profession, one or more interests, a skill-level, and a gender.

104. The method of claim 102, wherein
the meta-data is associated with one or more search results associated the search criteria object and includes at least one of: a topic, a genre, a skill-level, and a profession.

105. The method of claim 102, wherein
the meta-data identifies one or more other information items associated with the search criteria object.

106. The method of claim 102, including
enabling the user to recall the trace of the modifications to the current search criteria at a subsequent period of time and at least one of the select search results and the changes to the search criteria objects associated with the modification, and to continue to modify the recalled current search criteria.

107. The method of claim 106, including, automatically:
re-submitting the current search criteria to the search engine,
receiving subsequent search results at a subsequent time, and
storing the subsequent search results associated with the current search criteria over time.

108. The method of claim 107, including
reporting differences between the search results and the subsequent search results.

109. The method of claim 65, including
displaying the current search criteria, and a plurality of similar search criteria objects.

110. The method of claim 109, including
determining relationships among the plurality of similar search criteria objects, and
displaying the relationships among the plurality of similar search criteria objects using a graphical representation of the relationships.

111. The method of claim 110, wherein
the graphic representation includes a network of nodes with links between the nodes.

112. The method of claim 111, wherein
the relationships include a similarity weighting factor between pairs of similar search criteria objects, and
the user interface is configured to configure the graphic representation based on the similarity weighting factors.

113. The method of claim 109, including
determining a measure of similarity between the current search criteria and each of the plurality of similar search criteria objects, and
displaying the measure of similarity using a graphical representation of the measure.

114. The method of claim 109, including
displaying one or more search results associated with the plurality of similar search criteria objects.

115. The method of claim 109, including
facilitating the user's modifying of the current search criteria by graphic manipulation of the displayed plurality of similar search criteria objects.

116. A method comprising:
initiating a search session,
defining search criteria for submission to a search engine,
receiving search results from the search engine,
presenting prior search criteria and prior search results to a user,
modifying the search criteria for submission to a search engine based on user feedback,
pausing the search session by storing a current state of the search session to a memory, and
resuming the search session at a subsequent time by recalling the current state of the search session from the memory.

117. The method of claim 116, wherein
the state of the search session includes the search criteria and one or more of the prior search criteria and prior search results.

118. The method of claim 117, wherein
the state of the search session includes a context that is associated with the search session.

119. The method of claim 118, wherein
the context includes one or more demographics associated with the user.

120. The method of claim 119, wherein
the demographics include one or more of: an age, a gender, a profession, an interest, and a skill-level.

121. The method of claim 117, wherein
the state of the search session includes a trace of modifications of the search criteria over time.

122. The method of claim 121, wherein
the state of the search session includes meta-data associated with at least one of the past search criteria and the past search results.

123. The method of claim 122, wherein
the meta-data includes at least one of: a measure of effectiveness of the past search criteria, a frequency of use of the past search criteria, a time of last use of the past search criteria, and a user comment related to the past search criteria.

124. The method of claim 122, wherein
the meta-data includes at least one of: a measure of effectiveness of the past search result, a frequency of access to material associated with the past search result, a time of last access to the material, and a user comment related to the past search result.

125. The method of claim 122, wherein
the user comment includes at least one of: a satisfaction rating, a context, a skill-level, a field of search, and a link to other material.

126. The method of claim 116, including, automatically:
resuming the search session at a subsequent time,
resubmitting the search criteria to the search engine,
receiving subsequent search results from the search engine, and
pausing the search session by storing a new current state of the search session to the memory.

127. The method of claim 126, wherein
the controller is configured to notify the user of differences between the search results and the subsequent search results.
